(19) United States
(12) Patent Application Publication
(10) Pub. No.: US 2012/0231209 A1
(43) Pub. Date: Sep. 13, 2012

(54) METHODS AND SYSTEMS FOR ACCURATELY PIECING BLOCKS WITH CORNER TRIANGLES

(76) Inventor: Ruthanna Louise Grihalva, Bluffton, OH (US)

(21) Appl. No.: 13/412,201

(22) Filed: Mar. 5, 2012

Related U.S. Application Data
(60) Provisional application No. 61/451,261, filed on Mar. 10, 2011.

(51) Int. Cl. B32B 3/06; D05B 11/00

(52) U.S. Cl. 428/102; 112/475.01; 112/117

(57) ABSTRACT

A method for joining pieces of material includes providing a base unit of material having at least two sides meeting at a first corner, measuring along each of the two sides an equal distance from the first corner and marking each end point on a backside of the base unit, marking a sewing line on the backside of the base unit between the two end points, providing a triangular piece of material having two sides of equal length meeting at a second corner, placing the triangular piece under the base unit with the second corner pointing away from the first corner and a hypotenuse connecting the two sides of the triangular piece substantially parallel to and offset from the sewing line by a second predetermined distance toward the first corner, and sewing the base unit and the triangular piece together along the sewing line to form a seam.

### CROSS REFERENCE TO RELATED APPLICATIONS

This application claims the benefit of U.S. Provisional Application No. 61/451,261, filed Mar. 10, 2011, which is incorporated by reference.

### FIELD OF THE INVENTION

Aspects of the present invention relate to the field of quilting, more particularly to methods and systems for piecing quilt blocks, regardless of size or shape, that have one or more corners replaced with a corner triangle.

### BACKGROUND

Quilting, or patchwork, involves sewing several layers of fabric or other suitable material together to form a final product, such as a quilt. Often, at least one of these layers, such as a quilt top, for example, includes a series of blocks pieced together. The quilt top may, in turn, be stitched to a back piece of fabric or other suitable material, which may or may not also include a series of blocks pieced together. In addition, the stitched layers of the quilt top and the back piece may optionally sandwich a middle layer of material, such as, for example, batting to provide insulation.

A pieced block often consists of one or more sections arranged in a distinctive decorative pattern. Most sections consist of one or more fabrics joined together or a base unit having additional fabric pieces that are sewed onto the base unit to create a distinctive look and feel to the finished products. Finished products may include, for example, quilt blocks, quilt tops, quilt backs, quilts, bedspreads, pillowcases, table décor, wall hangings, comforters, clothing, personal accessories such as hand bags and totes, throws, baby blankets and similar items that can include pieced blocks. In some cases, it is desirable to replace one or more corners of a base unit with a corner triangle made from a different piece of fabric to create a distinctive appearance and/or decorative pattern.

Current methods of providing a corner triangle on a base unit often result in the integrity of the base unit being compromised and/or dimensions of the corner triangle not matching those of the base unit, creating offsets and/or discrepancies that affect the appearance of the final product and/or make the piecing of multiple blocks into an organized arrangement difficult. For example, some current methods focus on the exact dimensions of the corner triangle prior to the corner triangle being cut, manipulated, and attached to the base unit. Other methods rely on printing a triangle pattern on paper-like products that serve as a guide (e.g., paper piecing) for the quilter. “Scant” techniques may be used that require a quilter to shave, for example, a “scant quarter inch” off of the seam allowances. However, the amount to be shaved is random and varies depending on the quilter, fabric, sewing machine and/or thread size, often resulting in inaccuracies when the block is finalized.

The most common of these methods is often referred to as “Sew & Flip”. The “Sew & Flip” method focuses on pure geometry of the new corner triangle, relying entirely on the fact that a square folded in half diagonally produces a right isosceles triangle. During the process of folding the corner triangle into its final position, the corner square, which was previously cut to the exact, predetermined size needed, becomes reduced in size and too small to reach the corner because of the exactness of the original measurement. The causes of this problem are many, some of which include, but are not limited to: the act of sewing putting tension on the fabric to shorten its actual size; the characteristics of the media involved (e.g., fabric, thread, thread count, thickness, etc.); and/or the technique of applying the corner triangle to the base unit which includes the corner triangle being laid flat in an orientation opposite to its final position, the corner triangle being sewn to the base unit and then folded into the final position to reverse the orientation, thereby shortening its final size and reach toward what should be the corner of the block. The result of the “Sew & Flip” method is that the edges of the resulting block are often not straight, the resulting block might not have the proper corner angle, the points created between two corners might be cut off when “squaring” the block or attaching it to surrounding fabric, there might be insufficient corner fabric for a proper seam allowance, fabric may be wasted when making corners in multiples of two, and fabric might be pulled into the sewing machine's throat plate when sewing the base unit and the corner triangle together.

The “Template” method involves the quilter cutting the base unit and the corner triangle from a template and attaching them together with a seam allowance. By using a template, the two pieces are cut to an exact size. Although the base unit is cut to a predetermined size, the focus is on the corner triangle, which is also cut to its predetermined size. This technique results in the same problems noted above with respect to the “Sew & Flip” method, except possibly the waste of fabric.

The “Free-Sew” method is similar to the “Template” method except that the quilter measures the fabric for cutting with a ruler rather than using a template. Again, the focus of the process is on the predetermined size of the replacement corner triangle, resulting in the same problems noted above, except possibly the waste of fabric.

“Paper Piecing” has a pattern printed on a paper product, which is attached to the fabric to be sewn. The fabric with the paper product attached is sewn and then trimmed to the proper size, after which the paper is removed. Paper Piecing may avoid some of the problems discussed above with respect to the various other methods. However, other problems arise when using the “Paper Piecing” method. For example, the pattern may be reduced or altered by the process used to produce the pattern on the paper (e.g., printing and/or copying), the paper tends to block the visibility of the fabric being manipulated and sewn, causing substantial difficulty for the quilter, removal of the paper pattern can cause the seams to unravel, the amount of fabric discarded is high, and there is often other equipment needed for the copying and/or printing.

New methods and tools are needed for replacing a corner(s) of a base unit(s) with a corner triangle(s) that avoids the problems noted above with respect to current methods while maintaining the integrity of the original base unit(s).

### SUMMARY

Aspects of the present invention advantageously provide methods and systems for replacing a corner(s) of a base unit(s) with a corner triangle(s).

In accordance with other aspects of the present invention, a method for joining pieces of material includes providing a base unit having at least two sides meeting at a first corner, measuring along each of the two sides an equal distance from the first corner and marking each end point on a backside of the base unit, marking a sewing line on the backside of the base unit between the two end points, providing a triangular piece of material having two sides of equal length meeting at a second corner, placing the triangular piece of material under the base unit with the second corner pointing away from the first corner, wherein a hypotenuse connecting the two sides of the triangular piece is offset from the sewing line by a second predetermined distance toward the first corner, and sewing the base unit and the triangular piece together along the marked sewing line to form a seam, trimming excess portions of the triangular piece extending beyond the two sides of the base unit, and trimming the base unit along a line substantially adjacent to the hypotenuse of the triangular piece to remove a corner portion of the base unit that includes the first corner.

In accordance with other aspects of the present invention, a block includes at least a top portion pieced together according to the method of claim 1.

There has thus been outlined, rather broadly, certain embodiments of the invention in order that the detailed description thereof may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting. For example, although sometimes referred to herein as fabric, the pieces to be joined may be made from any suitable material, including paper, plastics (e.g., polyethylene, polypropylene, polystyrene, polyvinyl chloride, polytetrafluoroethylene, nylon), and/or animal hide, to name just a few.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and constitute a part of this specification, illustrate exemplary embodiments consistent with the invention, and, together with the description, serve to explain the principles of the invention.

FIGS. 1A-1E depict exemplary configurations of a base unit having a corner triangle, in accordance with certain aspects of the present invention;

FIGS. 2A-2D illustrate exemplary configurations of a plurality of individual quilt blocks combined to create larger blocks or designs, in accordance with certain aspects of the present invention;

FIG. 3 depicts a front side view of a base unit and corner triangle, in accordance with certain aspects of the present invention;

FIG. 4 depicts a backside view of a base unit and an optional ruler, in accordance with certain aspects of the present invention;

FIG. 5 depicts a backside view of a base unit and optional ruler, in accordance with certain aspects of the present invention;

FIG. 6 depicts an optional ruler, in accordance with certain aspects of the present invention;

FIG. 7 depicts a close up view of a portion of the optional ruler shown in FIG. 6, in accordance with certain aspects of the present invention;

FIG. 8 depicts a corner square sectioned into two corner triangles, in accordance with certain aspects of the present invention;

FIG. 9 depicts a backside view of a base unit and an unfinished corner triangle, in accordance with certain aspects of the present invention;

FIG. 10 depicts a backside view of a base unit and an unfinished corner triangle prepared for joining, in accordance with certain aspects of the present invention;

FIGS. 11A-11B depict a backside view of a base unit and corner triangle in various configurations for ironing, in accordance with certain aspects of the present invention;

FIGS. 12A-12B depict exemplary configurations of a base unit and corner triangle being trimmed, in accordance with certain aspects of the present invention; and

FIG. 13 depicts a base unit prepared for removal of the corner replaced by the corner triangle, in accordance with certain aspects of the present invention.

### DETAILED DESCRIPTION

The invention will now be described with reference to the drawing figures, in which like reference numerals refer to like parts throughout.

Various aspects of the method(s) and system(s) described herein may be illustrated by describing components that are connected, attached, and/or joined together. As used herein, the terms “connected”, “attached”, and/or “joined” are used to indicate either a direct connection between two components or, where appropriate, an indirect connection to one another through intervening or intermediate components. In contrast, if a component is referred to as being “directly coupled”, “directly attached”, and/or “directly joined” to another component, there are no intervening elements present.

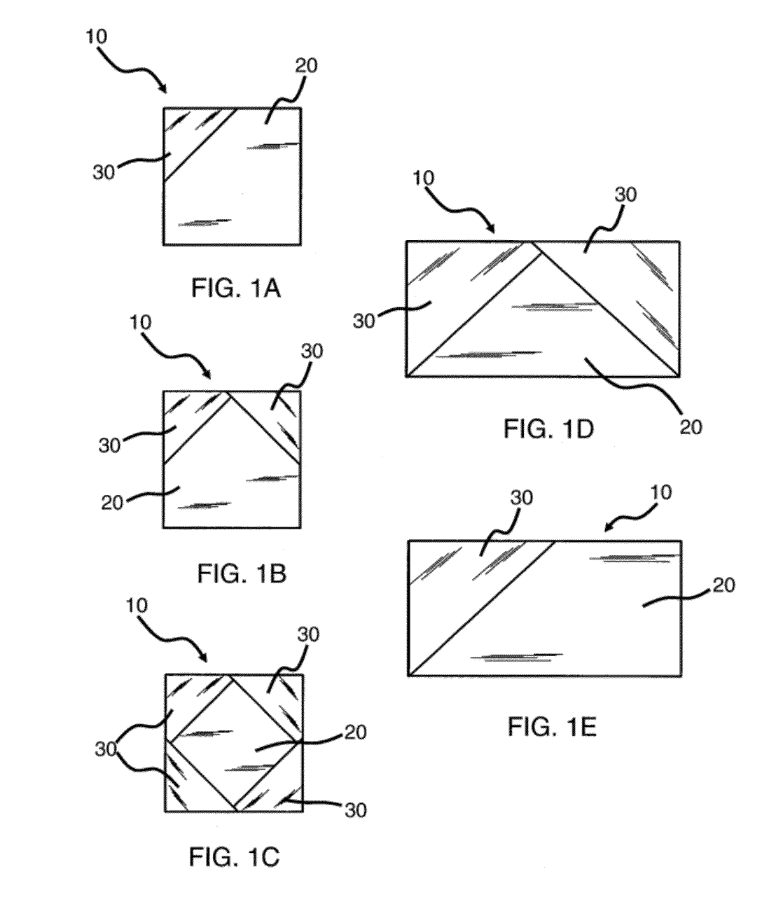

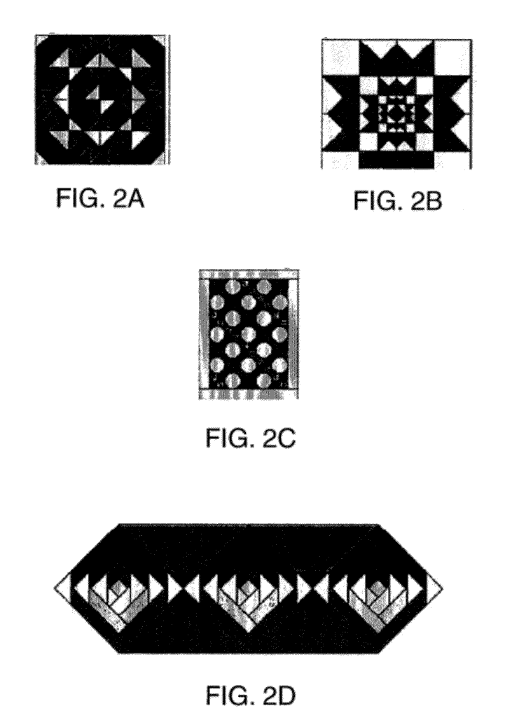

The present invention relates to an accurate method and system to enable piecing of base units for blocks having one or more corners replaced with a corner triangle(s), for example, regardless of the size and/or shape of the individual blocks. As shown in FIGS. 1A-1E, for example, a block section 10 of any size or shape may include a base unit 20 having one or more corners that are replaced with a corner triangle 30 of fabric separately attached to the base unit 20. Although the present invention contemplates base units and corner triangles of various shapes, sizes, and geometric dimensions, as shown in FIGS. 1A-1E, the corner of the base unit 20 to be replaced may be a right angle corner and the corner triangle 30 a right isosceles triangle. The size of the triangle 30 may be determined by any suitable means including, for example, a pattern, template, design, drawing, notes, electronic media, or based upon the size of a pre-made base unit 20. The shape of the base unit 20 may be any suitable shape, including, for example, a square, rectangle, or triangle. Moreover, as shown in the exemplary illustrations of FIGS. 2A-2D, individual block sections 10 may be combined to create larger blocks or designs.

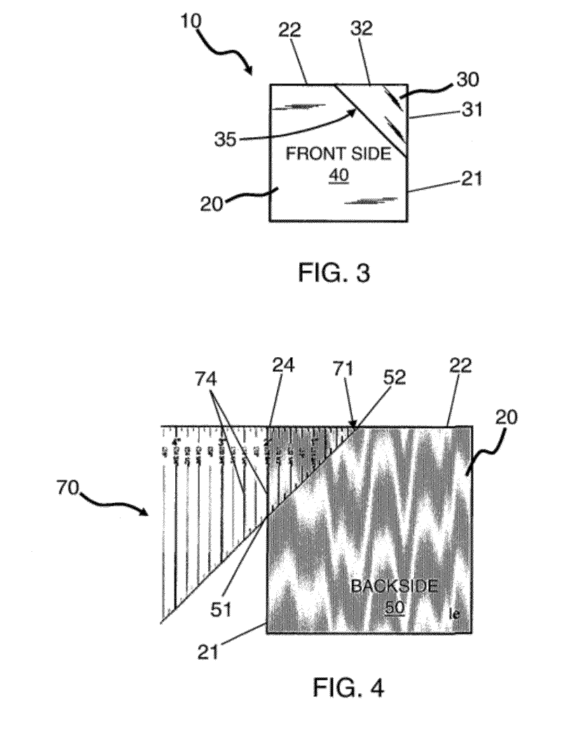

The size of the corner triangle 30 may be determined based on the size of the base unit 20 and/or in accordance with a pattern, diagram, instructions, etc. As shown in FIG. 3, a finished corner triangle size provides for sides 31 and 32 that align with the sides 21 and 22 of the base unit 20. A seam 35 can be seen marking the demarcation between the base unit 20 and the corner triangle 30 when viewed from a front side 40 of the base unit 20. As detailed below, an unfinished corner triangle size is equal to the finished triangle size plus an allowance of extra material as determined in accordance with the methods of the present invention.

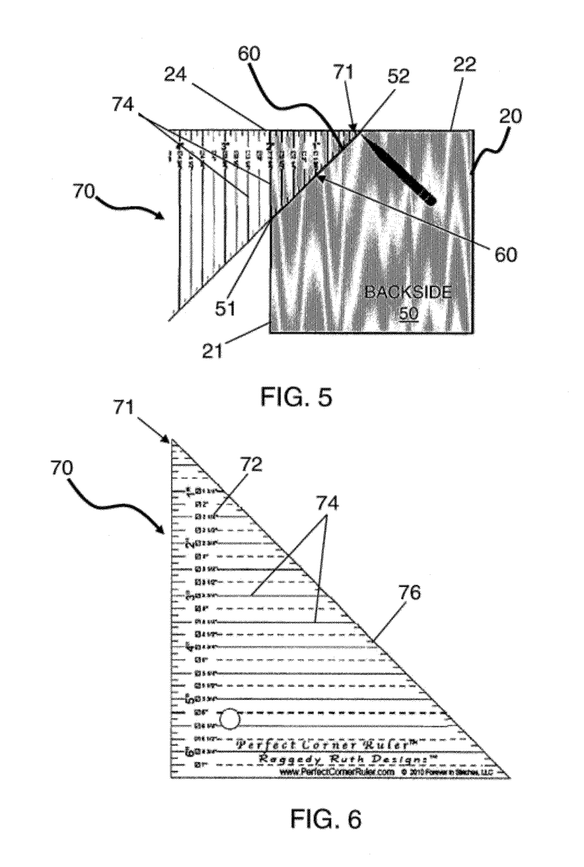

A method of providing a block section 10 having a corner triangle 30 attached to a base unit 20 is described with reference to the remaining figures. As shown in FIG. 4, the base unit 20 is placed so that the backside 50 of the base unit 20 is facing the quilter. In this manner, any markings to be made will not detract from a side of the base unit 20 to be viewed. A corner 24 of the base unit 20 to be replaced with the corner triangle 30 is located. When viewed from the backside 50, the corner 24 is the corresponding corner from where the corner triangle 30 should appear on the front side 40. As shown in FIG. 5, from the corner 24 to be replaced, the quilter measures and makes a mark at a predetermined distance on the base unit 20 along both the respective sides 21 and 22 to indicate end points 51 and 52 for marking a sewing line 60. The quilter marks the sewing line 60 by drawing a straight line between the two end points 51 and 52. The marked sewing line 60 may now be used to effectively establish the relationship of the corner triangle 30 to the base unit 20.

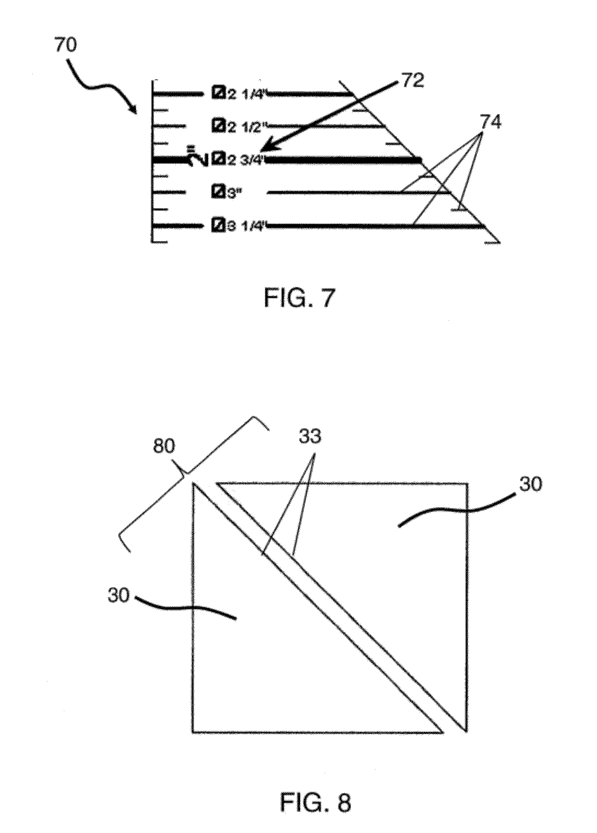

As shown in FIGS. 6 and 7, a specialized ruler 70 may be used to assist in the method described herein and, in particular, for determining an unfinished size of the corner triangle 30. For example, to determine the size of a needed corner square 80 (see FIG. 8) for making the corner triangle 30, ¾ of an inch may be added to the distance used to mark end points 51 and 52. Although ¾ of an inch is used for illustrative purposes herein, any predetermined length may be used that is sufficient to provide a safety margin of fabric for sewing the seam 35 when the corner triangle 30 covers the corner 24. Therefore, for example, if 2 inches is the measurement to each end point 51 and 52 from the corner 24 of the base unit 20, as shown in FIG. 7, the specialized ruler 70 may be used to easily correlate the necessary corner square size by viewing the corner square conversion measurements 72 provided on the specialized ruler 70, which in this example would be 2¾ inches, equal to 2 inches plus the ¾ inch safety margin. By providing a safety margin of fabric to appropriately cover the corner 24 allows for an ample seam allowance on both the base unit 20 and the corner triangle 30 so that sewing commences on fabric, rather than on or near a raw edge that can cause the fabric to be drawn into the sewing machine's throat plate during the sewing process. The corner triangle 30 may also align easily to fit with the base unit 20 after being stitched and ironed, for example, without the problems experienced by current methods, including that ample fabric is provided for placement under the sewing machine's presser foot to keep fabric ends from being drawn into the sewing machine's throat plate.

Aspects of the specialized ruler 70 allow for measurements that begin at one or both of the non-right angle corners 71 of the specialized ruler 70 so as to proceed to the right angle corner 24 of the ruler. In other words, the origin for measurement purposes, i.e., the number zero, begins at one or both of the non-right angle corners and increases to a predetermined length measurement that terminates at the right angle corner 24 of the ruler. Accordingly, as shown in FIGS. 4-6, because the origin of the ruler begins at the non-right angle corner 71 of the ruler 70, measuring the distance to mark the endpoints 51 and 52 for drawing the sewing line 60 is as easy as lining the 2 inch measuring line with the corner 24. Alignment lines 74 on the specialized ruler 70 extend at right angles to the side of the measurement to a hypotenuse side 76 that may mark the sewing line 60. Aligning the appropriate alignment line 74, in this case the alignment line 74 associated with 2 inches, with the appropriate side of the base unit 20, in this case the side 21, allows the quilter to quickly and easily mark the sewing line 60 with the knowledge that the distance from the corner 24 to the end point 51 is exactly the same distance as the distance from the corner 24 to the end point 51. Although the measurements described herein may be described with respect to the optional specialized ruler 70, any means for making the measurements in accordance with the present invention are contemplated.

Determining the appropriate size of the corner triangle 30 may begin with determining the size of a corner square 80. As explained above, the corner square conversion measurements 72 may be provided on the ruler, separated by an icon, for example, or providing on an accompanying pattern, instructions, web-page, etc. As shown in FIG. 8, by knowing the size of the corner square 80 that correlates to the distance used to mark the end points 51 and 52 for the sewing line 60, a corner square 80 may be cut from the desired fabric to have a side length equal to the corner square conversion size. The corner square 80 may then be cut diagonally between two corners to make two corner triangles 30 of unfinished size, each having a hypotenuse 33. One of the corner triangles may be used as a first corner triangle and the other corner triangle may be used for another corner triangle.

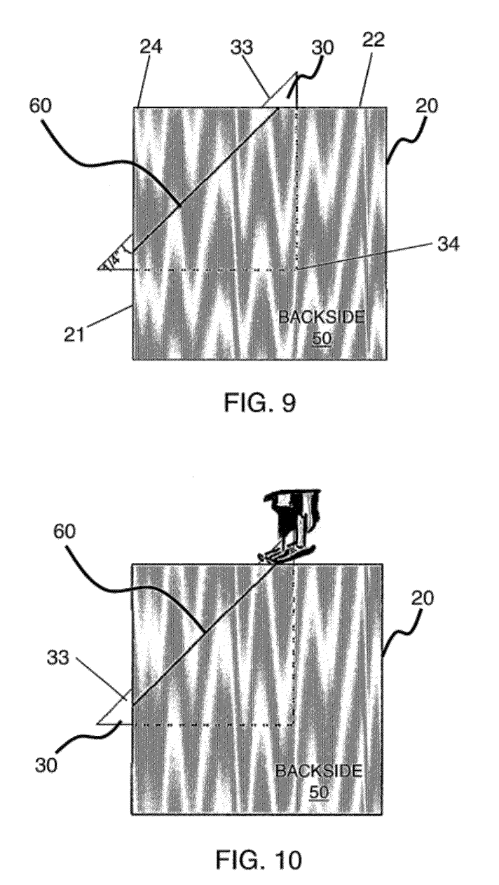

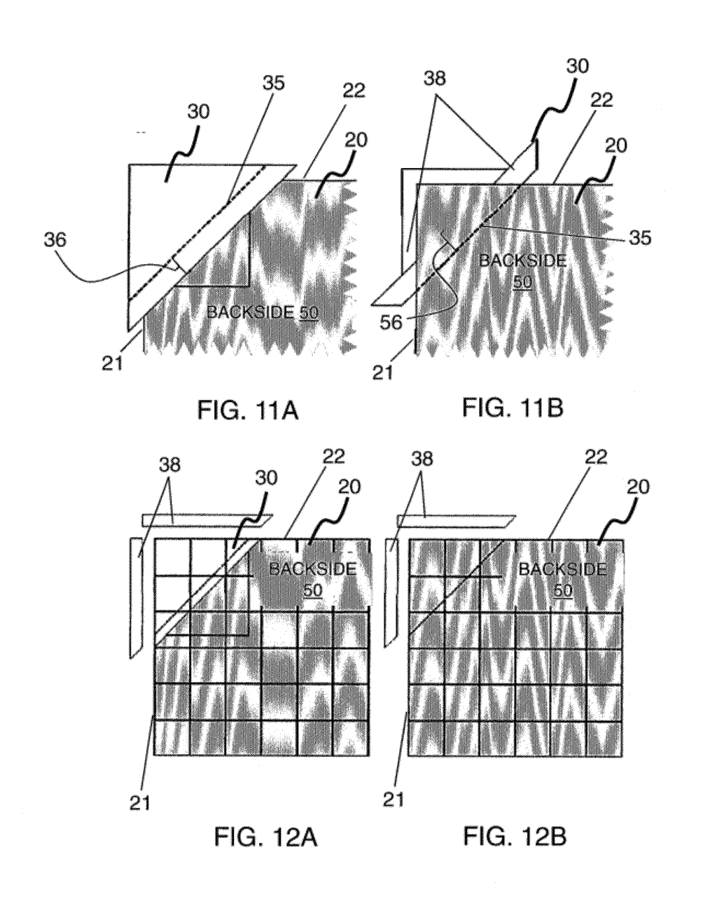

As shown in FIG. 9, one of the two corner triangles 30 of unfinished size may be placed, with its front side facing the quilter, underneath the base unit 20, which remains positioned with the backside 50 up. The corner triangle 30 may be placed so that the right angle corner 34 of the corner triangle 30 points away from the right angle corner 24 of the base unit 20 and the hypotenuse 33 extends parallel to and a predetermined distance, for example, a ¼ inch, from the sewing line 60 toward the corner 24 to be replaced. The corner triangle fabric should extend beyond the edges 21 and 22 of the base unit 20. Because of the effectiveness of the ruler 70 in providing exact measurements for determining the size of the corner triangle 30 and, for example, for marking the sewing line 60, the quilter may effectively and quickly align the corner triangle 30 in proper position beneath the base unit 20. The quilter may, for example, “eyeball” the predetermined distance of ¼ inch as well as perform a visible check that the corner triangle 30 is properly aligned by ensuring the portions 38 (see FIGS. 11B and 12A-12B) of the corner triangle 30 extending beyond the respective sides 21 and 22 are, respectively, substantially equal. To maintain the position of the unfinished corner triangle 30 in relation to the base unit 20, pins may be used and/or any suitable device for providing the necessary grip and hold between the two pieces. By placing the corner triangle 30 under the base unit 20, sewing can easily be performed in relation to the base unit 20 because of the unobstructed visibility of the sewing line 60 marked on the backside 50 of the base unit 20. Moreover, the positioning of the corner triangle 30 to extend beyond the base unit allows the corner triangle 30 to be trimmed to the original base unit 20 size while allowing a seam allowance of ample fabric to be provided under the sewing machine's presser foot, preventing the edge of the fabric from being grabbed into the machine's throat plate.

As shown in FIG. 10, the quilter may sew along the sewing line 60, starting with the sewing machine's presser foot on the corner triangle fabric. As shown in FIGS. 11A and 11B, the method provided herein ensures an ample seam allowance 36 of the corner triangle 30 and an ample seam allowance 56 of the base unit 20. The seam 35 may be ironed by folding down the corner of the base unit 20 that is being replaced and ironing towards the center of the base unit 20 (FIG. 11A) and/or folding the corner triangle 30 back towards the corner to be replaced, pivoting along the seam 35, and ironing towards the corner (FIG. 11B).

As shown in FIGS. 12A and 12B, which correspond to the positions shown in FIGS. 11A and 11B, respectively, the portions 38 of the unfinished corner triangle 30 extending beyond the based unit 20 are trimmed to align with the sides 21 and 22 of the base unit 20. A ruler, grid, or any other desired tool or technique may be used to assist in performance of this step.

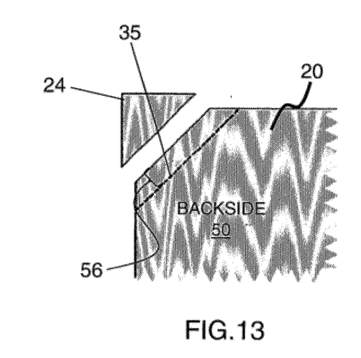

As shown in FIG. 13, the corner triangle 30 may be folded under the base unit 20 in order to trim the corner 24 from the base unit 20 down to, for example, the seam allowances 36 and/or 56 of the corner triangle 30 and/or the base unit 20, respectively. The sequence of the steps illustrated in FIGS. 11-13 may be performed interchangeably.

It is to be understood that any feature described in relation to any one aspect may be used alone, or in combination with other features described, and may also be used in combination with one or more features of any other of the disclosed aspects, or any combination of any other of the disclosed aspects. Furthermore, equivalents and modifications not described above may also be employed without departing from the scope of the disclosed subject matter.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method for joining pieces of material comprising:
providing a base unit of material having at least two sides meeting at a first corner;
measuring along each of the two sides an equal distance from the first corner and marking each end point on a backside of the base unit;
marking a sewing line on the backside of the base unit between the two end points;
providing a triangular piece of material having two sides of equal length meeting at a second corner, each of the two sides being longer than the equal distance by a predetermined length;
placing the triangular piece under the base unit with the second corner pointing away from the first corner and a hypotenuse connecting the two sides of the triangular piece substantially parallel to and offset from the sewing line by a second predetermined distance toward the first corner;
sewing the base unit and the triangular piece together along the sewing line to form a seam;
trimming excess portions of the triangular piece extending beyond the two sides of the base unit; and
trimming the base unit along a line substantially adjacent to the hypotenuse of the triangular piece to remove a corner portion of the base unit that includes the first corner.

2. The method of claim 1, further comprising:
folding the triangular piece along the seam to extend the two sides of the triangular piece beyond the two sides of the base unit.

3. The method of claim 3, further comprising:
ironing the seam.

4. The method of claim 1, further comprising:
measuring a square piece of material having a side length equal to the sum of the equal distance and the predetermined length; and
cutting the square piece of material diagonally between two corners of the square piece to create the triangular piece.

5. The method of claim 1, further comprising:
using a measuring device capable of simultaneously measuring the equal distance from the first corner to at least one of the end points and providing a surface to use in marking the sewing line.

6. The method of claim 5, wherein the measuring device includes conversion markings for determining the length of the two sides of the triangular piece based on the equal distance.

7. The method of claim 1, wherein the predetermined distance is at least ¾ of an inch.

8. The method of claim 1, wherein the second predetermined distance is at least ¼ of an inch.

9. A block comprising at least a top portion pieced together according to the method of claim 1.

10. The block of claim 9, further comprising:
a back piece stitched to the top portion.

11. The block of claim 10, further comprising:
a middle layer of material provided between the top portion and the back piece.

12. A system for piecing materials together, the system comprising:
a measurement device having a right angle corner, at least one non-right angle corner, and a series of measurement indications, wherein an origin for the measurement indications begins at the non-right angle corner and terminates at the right angle corner.

13. The system of claim 12, further comprising:
a base unit piece of material.

14. The system of claim 13, further comprising:
a second piece of material for attaching to the base unit.

15. The system of claim 12, wherein the measurement device further comprises a second non-right angle corner and a hypotenuse connecting the non-right angle corner and the second non-right angle corner.

16. The system of claim 15, wherein the measurement device further comprises a series of alignment lines, each alignment line associated with a corresponding measurement indication and extending to the hypotenuse.

17. The system of claim 12, wherein the measurement device further comprises a series of conversion markings, each conversion marking associated with a corresponding measurement indication.

18. The system of claim 12, wherein the measurement device is comprised of a transparent material.

19. The system of claim 12, further comprising:
a set of instructions for using the measurement device.
